(19) United States
(12) Patent Application Publication
(10) Pub. No.: US 2023/0323509 A1
(43) Pub. Date: Oct. 12, 2023

(54) Weak Acid Lixiviants for Recovery of Alkaline Earth Metals

(71) Applicant: LIXIVIA, INC., Santa Barbara, CA (US)

(72) Inventor: Michael D Wyrsta, Santa Barbara, CA (US)

(21) Appl. No.: 18/025,292

(22) PCT Filed: Sep. 10, 2021
(86) PCT No.: PCT/US21/49813

§ 371 Date: Mar. 8, 2023

Related U.S. Application Data
(60) Provisional application No. 63/077,365, filed on Sep. 11, 2020.

(51) Int. Cl. C22B 26/20; C22B 3/16; C22B 3/22; C22B 3/44

(52) U.S. Cl. CPC C22B 26/20; C22B 3/165; C22B 3/22; C22B 3/44

(57) ABSTRACT

Weak acid lixiviants are used to selectively extract calcium from various sources (e.g., steel slag, impure lime, dolomite). Preferably, non-amine weak acids (e.g., weak acids that do not include an amine) as lixiviants are used. Such lixiviants can be used in stoichiometric quantities relative to calcium content of the calcium source material.

This application claims the benefit of U.S. Provisional Patent Application Ser. No. 63/077,365 filed on Sep. 11, 2020. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is recovery of metals, in particular using hydrometallurgy.

### BACKGROUND

The background description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply

There is a long-standing need to efficiently and cost-effectively recover commercially valuable metals from low yield sources, such as mine tailings.

Historically, it has been especially desirable to recover alkaline earth elements. Alkaline earth elements, also known as beryllium group elements, include beryllium (Be), magnesium (Mg), calcium (Ca), strontium (Sr), barium (Ba) and radium, (Ra), which range widely in abundance. Applications of these commercially important metals also vary widely, and include uses as dopants in electronic components, structural materials, and in the production foods and pharmaceuticals.

Methods of isolating of one member of the alkaline earth family, calcium, from minerals such as limestone, have been known since ancient times. In a typical process limestone is calcined or otherwise roasted to produce calcium oxide (CaO), or quicklime. This material can be reacted with water to produce calcium hydroxide (Ca(OH)₂), or slaked lime. Calcium hydroxide, in turn, can be suspended in water and reacted with dissolved carbon dioxide (CO₂) to form calcium carbonate (CaCO₃), which has a variety of uses. Approaches that have been used to isolate other members of this family of elements often involve the production of insoluble hydroxides and oxides using elevated temperatures or strong acids. Such approaches, however, are not suitable for many sources of alkaline earth elements (such as steel slag) and are not sufficiently selective to be readily applied to mixtures of alkaline earth elements.

Hydrometallurgy can also be used to isolate metals from a variety of minerals, ores, and other sources. Typically, ore is crushed and pulverized to increase the surface area prior to exposure to the solution (also known as a lixiviant). Suitable lixiviants solubilize the desired metal and leave behind undesirable contaminants. Following collection of the lixiviant, the metal can be recovered from the solution by various means, such as by electrodeposition or by precipitation from the solution.

Previously known methods of hydrometallurgy have several problems. Identification of lixiviants that provide efficient and selective extraction of the desired metal or metals has been a significant technical barrier to their adoption in the isolation of some metals. Similarly, the expense of lixiviant components, and difficulties in adapting such techniques to current production plants, has limited their use.

Approaches have been devised to address these issues. United States Patent Application No. 2004/0228783 (to Harris, Lakshmanan, and Sridhar) describes the use of magnesium salts (in addition to hydrochloric acid) as a component of a highly acidic lixiviant used for recovery of other metals from their oxides, with recovery of magnesium oxide from the spent lixiviant by treatment with peroxide. Such highly acidic and oxidative conditions, however, present numerous production and potential environmental hazards that limit their utility. In an approach disclosed in U.S. Pat. No. 5,939,034 (to Virnig and Michael), metals are solubilized in an ammoniacal thiosulfate solution and extracted into an immiscible organic phase containing guanidyl or quaternary amine compounds. Metals are then recovered from the organic phase by electroplating.

A similar approach is disclosed in U.S. Pat. No. 6,951,960 (to Perraud) in which metals are extracted from an aqueous phase into an organic phase that contains an amine chloride. The organic phase is then contacted with a chloride-free aqueous phase that extracts metal chlorides from the organic phase. Amines are then regenerated in the organic phase by exposure to aqueous hydrochloric acid. Application to alkaline earth elements (for example, calcium) is not clear, however, and the disclosed methods necessarily involve the use of expensive and potentially toxic organic solvents.

In a related approach, European Patent Application No. EP1309392 (to Kocherginsky and Grischenko) discloses a membrane-based method in which copper is initially complexed with ammonia or organic amines. The copper:ammonia complexes are captured in an organic phase contained within the pores of a porous membrane, and the copper is transferred to an extracting agent held on the opposing side of the membrane. Such an approach, however, requires the use of complex equipment, and processing capacity is necessarily limited by the available surface area of the membrane.

Methods for capturing CO₂ could be used to recover alkaline earth metals, but to date no one has appreciated that such could be done. Kodama et al. (Energy 33(2008), 776-784) discloses a method for CO₂ capture using a calcium silicate (₂CaOSiO₂) in association with ammonium chloride (NH₄Cl). This reaction forms soluble calcium chloride (CaCl₂)), which is reacted with carbon dioxide (CO₂) under alkaline conditions to form insoluble calcium carbonate (CaCO₃) and release chloride ions (Cl—).

Kodama et al. uses clean forms of calcium to capture CO₂ but is silent in regard to the use of other alkaline earth elements in this chemistry. This is consistent with Kodoma et al. 's disclosure of the loss of a high percentage (approximately 20%) of the NH₄Cl by the disclosed process, requiring the use of additional equipment to capture ammonia vapor. In addition, Kodama appears to require the use of a dedicated source of high grade carbon dioxide. These characteristics result in significant process inefficiencies and cost requirements and raise significant environmental concerns. Japanese Patent Application No. 2005097072 (to Katsunori and Tateaki) discloses a similar method for CO₂ capture, in which ammonium chloride (NH₄Cl) is dissociated into ammonia gas (NH₃) and hydrochloric acid (HCl), the HCl being utilized to generate calcium chloride (CaCl₂) that is mixed with ammonium hydroxide (NH₄OH) for CO₂ capture, but similarly appears to require the use of high grade carbon dioxide.

International Application WO 2012/055750 (to Tavakkoli et al) discloses a method for purifying calcium carbonate (CaCO₃), in which impure CaCO₃ is converted to impure calcium oxide (CaO) by calcination. The resulting CaO is treated with ammonium chloride (NH₄Cl) to produce calcium chloride (CaCl₂), which is subsequently reacted with high purity carbon dioxide (CO₂) to produce CaCO₃ and NH₄Cl, with CaCO₃ being removed from the solution by crystallization with the aid of seed crystals. Without means for capturing or containing the ammonia gas that would result from such a process, however, it is not clear if the disclosed method can be adapted to an industrial scale.

More recently, work by the inventors has identified various amine-based lixiviants for use in efficiently extracting alkaline earth metals and other valuable metals from industrial waste, consumer waste, and traditionally low-yield sources. Examples of such lixiviants can be found in U.S. Pat. Nos. 9,347,111, 9,695,490, 9,738,950, 10,113,215, and 10,266,912. Such amine-containing lixiviants may not be suitable for all purposes, however.

Thus, there remains a need for compositions and methods that provide rapid, and efficient methods for recovery calcium and other alkaline earth metals with minimal environmental impact.

### SUMMARY OF THE INVENTION

The inventive subject matter provides apparatus, systems and methods in which weakly acidic compounds that do not include an amine group are used as lixiviants in the recovery of alkaline earth metals, such as calcium.

One embodiment of the inventive concept is a method for the recovery of an alkaline earth from a raw material by contacting a raw material comprising an alkaline earth (e.g., calcium) to a to a weak acid lixiviant that does not include an amine in a reactor, thereby generating an extracted raw material, a solubilized alkaline earth, and a spent lixiviant. The solubilized alkaline earth and the spent lixiviant are contacted with a precipitant, thereby generating an alkaline earth precipitate and a regenerated weak acid lixiviant. In some embodiments the precipitant is introduced into the reactor in a continuous or essentially continuous manner. The alkaline earth precipitate is separated from the regenerated weak acid lixiviant, at least apportion of which is returned to the reactor. The weak acid can be a weaker acid than carbonic acid, and in some embodiments is a weak organic acid (e.g., lactic acid, malic acid. and/or acetic acid). In some embodiments the extracted raw material is separated from a liquid phase that includes the solubilized alkaline earth and the spent lixiviant prior to contacting with the precipitant. In other embodiments the extracted raw material is separated from the alkaline earth precipitate and from the regenerated weak organic acid lixiviant following contacting with the precipitant. Such a separation can be performed on the basis of density and/or particle size. In some embodiments the extracted raw material is subjected to further processing.

Various objects, features, aspects and advantages of the inventive subject matter will become more apparent from the following detailed description of preferred embodiments, along with the accompanying drawing figures.

### BRIEF DESCRIPTION OF THE DRAWINGS

FIG. 1: FIG. 1 shows a typical. pH profile for extraction with in-situ regeneration of a lixiviant of the inventive concept.

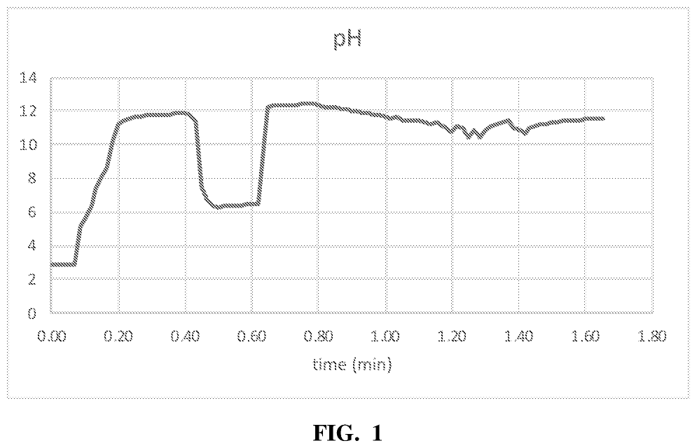

### DETAILED DESCRIPTION

The following description includes information that may be useful in understanding the present invention. It is not an admission that any of the information provided herein is prior art or relevant to the presently claimed invention, or that any publication specifically or implicitly referenced is prior art.

The inventive subject matter provides lixiviants to selectively extract calcium from various sources (e.g., steel slag, impure lime, dolomite) using non-amine weak acids (e.g., weak acids that do not include an amine) as lixiviants are described herein. In some embodiments such lixiviants are used in stoichiometric quantities (relative to calcium content of the calcium source material). In other embodiments such lixiviants are used in sub-stoichiometric quantities (relative to calcium content of the calcium source material). In still other embodiments such lixiviants are used in super-stoichiometric quantities (relative to calcium content of the calcium source material).

Within this application a weak acid is defined as an acidic compound that does not completely ionize in aqueous solution.

One should appreciate that the disclosed techniques provide many advantageous technical effects including efficient recovery of valuable metals from low quality or waste raw materials with minimal environmental impact. The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The calcium salt preparations so obtained can be utilized directly or can undergo further manipulations such as carbonation with CO₂ to generate precipitated calcium carbonate (PCC). Such a process can regenerate the initial lixiviant species for reuse. In some embodiments the non-amine containing weak organic acid can have a pKa that is less than that of carbonic acid (i.e. less than 6.36).

Inventors contemplate that a wide variety of non-amine containing organic acids are suitable for extraction of calcium and/or other alkaline earth metals from low value raw materials such as low grade limestone, steel slag, and ash (e.g., from furnaces, combustion of biomass, etc.) Suitable non-amine containing organic acids include, but are not limited to:

| Acid | pKa |
|---|---|
| formic acid | 3.75 |
| glyoxylic acid | 3.18 |
| oxalic acid (1) | 1.25 |
| oxalic acid (2) | 3.81 |
| acetic acid | 4.76 |
| thioacetic acid | 3.33 |
| glycolic acid | 3.83 |
| 2-propyonic acid | 1.84 |
| 2-butynoic acid | 2.62 |
| fumaric acid (1) | 3.02 |
| fumaric acid (2) | 4.38 |
| oxaloacetic acid (1) | 2.55 |
| oxaloacetic acid (2) | 4.37 |
| 3-butenoic acid | 4.34 |
| 2-oxobutanoic acid | 2.5 |
| acetoacetic acid | 3.6 |
| succinic acid (1) | 4.21 |
| succinic acid (2) | 5.64 |
| methylmalonic acid (1) | 3.07 |
| methylmalonic acid (2) | 5.76 |
| malic acid (1) | 3.4 |
| malic acid (2) | 5.11 |
| DL tartaric acid (1) | 3.03 |
| DL tartaric acid (2) | 4.37 |
| meso-tartaric acid (1) | 3.17 |
| meso-tartaric acid (2) | 4.91 |
| L-tartaric acid (1) | 2.98 |
| L-tartaric acid (2) | 4.34 |
| butanoic acid | 4.83 |
| 2-methylpropanoic acid | 4.84 |
| 3-hydoxybutanoic acid | 4.7 |
| 4-hydroxybutanoic acid | 4.72 |
| ethoxyacetic acid | 3.65 |
| acrylic acid | 4.25 |
| pyruvic acid | 2.39 |
| malonic acid (1) | 2.85 |
| malonic acid (2) | 5.7 |
| propanoic acid | 4.87 |
| lactic acid | 3.86 |
| barbituric acid | 4.01 |
| uric acid | 3.89 |
| 2-oxoglutaric acid (1) | 2.47 |
| 2-oxoglutaric acid (2) | 4.68 |
| glutaric acid (1) | 4.32 |
| glutaric acid (2) | 5.42 |
| methylsuccinic acid (1) | 4.13 |
| methylsuccinic acid (2) | 5.64 |
| pentanoic acid | 4.83 |
| 2-methylbutanoic acid | 4.8 |
| 3-methylbutanoic acid | 4.77 |
| 2,2-dimethylpropanoic acid | 5.03 |
| citric acid (1) | 3.13 |
| citric acid (2) | 4.76 |
| isocitric acid (1) | 3.29 |
| isocitric acid (2) | 4.71 |
| hexanoic acid | 4.85 |
| adipic acid (1) | 4.41 |
| adipic acid (2) | 5.41 |
| benzoic acid | 4.2 |
| cyclohexanecarboxylic acid | 4.91 |
| heptanoic acid | 4.89 |
| octanoic acid | 4.89 |
| ascorbic acid | 4.17 |

Alternatively, weak inorganic acids (e.g., H₃BO₃, HNO₂, H₃PO₄, H₂SO₃, HSO₄, HF) can be used as lixiviants in methods and compositions of the inventive concept. Use of such non-organic acids can avoid potential issues with organic decomposition and/or discoloration of products that are exposed to elevated temperature or stored for long periods of time.

Such lixiviant species can be used at concentrations ranging from 0.1 μM to 1 M or higher. As noted below, in some embodiments concentration of the lixiviant species is selected on the basis of calcium or other alkaline earth metal content of a raw or source material utilized in a method of the inventive concept.

In a typical method of the inventive concept, a source material that includes an insoluble salt or oxide of calcium (and/or another alkaline earth element) is contacted with an aqueous solution of a weak non-amine containing organic acid. Suitable raw materials include low grade limestone, slag from steelmaking operations; furnace ash, ash from combustion of biomass, etc. In some embodiments such raw materials can be calcined prior to contact with the weak non-amine containing acid solution. In preferred embodiments the raw material is sized by grinding, sifting, pulverizing, milling, or any suitable process into particulate form. Particles so produced can have a mean diameter ranging from about 100 μm to about 10 mm. In some embodiments such particles can be suspended in an aqueous solution to provide a slurry or mud that is readily transported by pumping or other fluid transport methods.

As detailed below, contact between the raw material and the weak non-amine containing organic acid results in the generation of a soluble calcium salt that includes the conjugate base of the weakly acidic lixiviant species, as well as an extracted raw material. Such extracted raw materials can be collected and further processed to recover additional metals. It should be appreciated that depletion of calcium from such raw materials results in relative enrichment of remaining metals. In some embodiments such extracted raw materials can be incorporated into building and construction materials, where removal of calcium content provides improved performance (e.g., resistance to weather and acid rain).

As noted above, in some embodiments the soluble calcium or alkaline earth salt can be utilized directly. Alternatively, in some embodiments it is desirable to recover the calcium or alkaline earth as a solid. In such embodiments the aqueous solution containing the solubilized calcium or alkaline earth salt can be contacted with a precipitant, which results in precipitation of the calcium/alkaline earth. For example, if carbon dioxide is used as a precipitant (e.g., through sparging with a CO₂ containing gas, addition of carbonate and/or bicarbonate salts, etc.) calcium can be recovered as calcium carbonate (CaCO₃). Such reactions can also regenerate the weakly acidic lixiviant species, which can be recycled back into the reaction for processing of additional raw material following separation of the remaining aqueous phase from the calcium/alkaline earth containing precipitate. Such separation can be accomplished by settling, decanting, filtration, centrifugation, or any suitable process. It should be appreciated that the choice of precipitant can be affected by the choice of non-amine containing organic acid precipitant, and that such regeneration of the lixiviant species greatly reduces both operational costs and environmental impact of such processes. Products (PCC, calcium salt solutions) from such processes can include residual lixiviant. In the case of PCC, the residual lixiviant can be reduced by washing.

It should be appreciated that the calcium/alkaline earth precipitates formed on the addition of precipitant can be relatively low density, flocculent precipitates that have considerably different density and/or hydrodynamic properties than that of the extracted raw material. Accordingly, while stepwise processes are described above continuous embodiments of such methods can be achieved using a separation method that can segregate aqueous phase, low density precipitate phase (containing calcium/alkaline earth) and extracted raw material from one another. For example, a centrifugal or cyclone separator can be used to separate these into separate product streams, with the aqueous phase (containing regenerated lixiviant species) being returned and mixed with additional raw material on a continuous basis.

In one example of the inventive concept, acetic acid can be as a lixiviant for extraction of calcium from BOF (blast oxygen furnace) slag. A solution of calcium acetate is obtained that can be utilized directly as a food additive, a Tofu coagulating agent, and/or as a component of a gelled fuel (e.g., Sterno®) when combined with an alcohol. Calcium acetate can also be used in the treatment of kidney disease as a phosphate binder. In an example of additional processing, calcium acetate so produced can be decomposed to calcium carbonate and acetone by heating to above 160° C.

Alternatively, when ascorbic acid is used as the lixiviant for the same BOF slag, carbonation of the resulting solution can provide PCC as a product that can be isolated by filtration. Such a process regenerates ascorbic acid which can be used for further selective extractions. Other lixiviants may afford the same kind of processes. Generally speaking, for use in precipitation reactions with CO₂ the lixiviant be sufficiently acidic such that is can react with calcium oxide or hydroxide, preferably with high selectivity, and also not be so acidic that it would react substantially with calcium carbonate.

In some embodiments, the lixiviant may be used in substantially sub-stoichiometric amounts and regenerated in-situ by addition of a stronger acid. For example, a small quantity of acetic acid can be used to initiate selective extraction of calcium from a material such as BOF slag. Subsequent additions of small aliquots (less than the moles of acetate in solution) of hydrochloric acid would yield a calcium containing solution that is substantially a dissolved chloride salt. The progress of such a reaction can be readily monitored by pH, which would indicate the endpoint of the selective extraction.

Steel slags are some of the most widely produced waste materials that contain significant quantities of calcium. When separated such calcium can be used to make valuable products (e.g., high purity PCC, lime, salts), and often increases the value of the starting material, typically by improving the physical properties (e.g., greatly reduced expansion) for uses in such applications as concrete and asphalt fillers.

A generic formula for steel slag composition is shown in Equation 1. Such materials can contain many different forms of calcium minerals as well as multiple impurities. Steel slag invariably includes some ferric oxide (Fe₂O₃) and often includes some manganese oxides (MnO, MnO₂, Mn₃O₄), magnesium oxide (MgO), as well as silica (SiO₂) and alumina (Al₂O₃). These are often co-crystalline materials with calcium oxide (CaO), as represented by the formula. However, there can be separate phases of any or all of these components. Furthermore, metallic iron)(Fe⁰) is typically present as well.

The formula in Equation 1 (CaOnMxOy) can also represent other materials besides steel slag. For example, Wollastonite (a calcium silicate) would be represented when n is approximately 1, M=Si, x=1, y=2. Dolime (a material prepared by calcining dolomite) can be represented by n approximately 1, M=Mg, x=1, y=1. Note that both of these materials typically contain silica (SiO₂) as well, which is why n has been described as approximately 1, to account for the impurity.

In Equation 1, the generic formula (CaOnMxOy) is meant to represent anything from a pure lime source (n=0), to very complex materials such as steel slag that include multiple impurities, each of which would have its own values of n, M, x and y. Within the actual chemical reaction represented, it should also be appreciated that a completely stoichiometric reaction is not necessarily what is represented. There can be instances in which the chosen lixiviant (HLix) does not react with certain calcium minerals, and there may also be instances in which it is desirable to leave some calcium behind and a substoichiometric amount of lixiviant would therefore be employed.

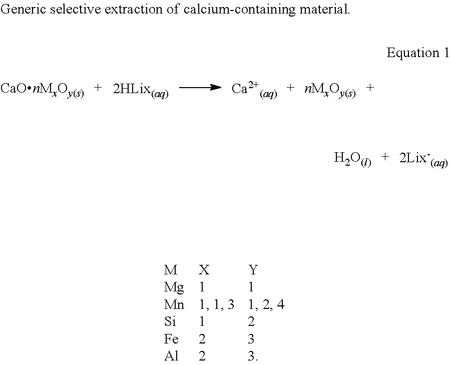

The precise mechanism of extraction is not precisely known but can occur by one or more of several different pathways. When pure lime is contacted with water a moderately exothermic hydration reaction occurs, producing calcium hydroxide (Equation 2). It is also well known that this product has some very limited solubility in water, as represented in Equation 3.

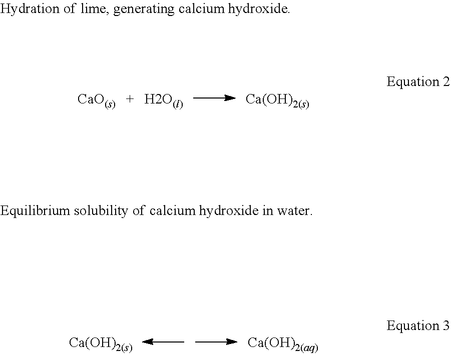

It is unclear whether or not the hydration (and subsequent semi-solubility of lime) of calcium oxide occurs appreciably (if at all) when present in such materials as steel slag. Regardless, choice of a proper lixiviant can result in selective extraction. The simplest way in this can occur is by direct reaction of a lixiviant acidic proton with CaO in the solid source material as depicted in Equation 1. The calcium-containing raw material can have separate CaO phases, which could directly react with a weakly acidic lixiviant according to Equation 4. It is also possible that slaking of CaO with water (to form hydroxide, Equation 2) within the starting material (either as a separate lime phase or as intercalated compounds, etc.) occurs, at least to some extent, in which case direct reaction between the lixiviant acid and either solid (Equation 4) or dissolved (Equation 6) calcium hydroxide can occur. It is possible that all of these mechanisms are happening simultaneously, albeit at different rates.

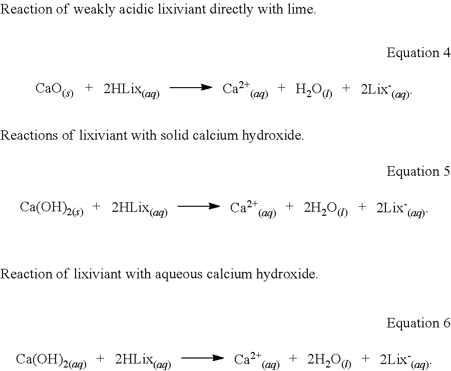

It should be noted that if the choice of acid is too strong, rather than a selective lixiviation, non-selective reaction with multiple metal species will occur. This scenario is given in Equation 7, in which partial or stoichiometric reaction may take place. Furthermore, if the chosen acid is strong enough (e.g., HCl) and the calcium containing material contains a metallic element such as iron (e.g., steel slag), direct reaction with the metal can occur, generating hydrogen gas as well (Equation 8). These reactions can be undesirable as they introduce impurities into the desired calcium extract.

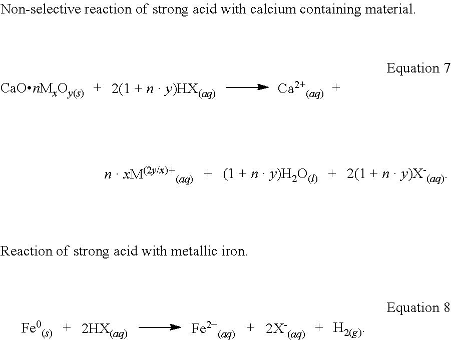

A selective extraction can be carried out by the action of a single component lixiviant, as depicted in Equation 1. This results in a solution containing a calcium salt of the lixiviant conjugate base. For example, if the lixiviant is acetic acid, a solution of calcium acetate is obtained. However, it is also possible to carry out selective extractions by using a sub-stoichiometric amount of lixiviant relative to calcium, by regenerating the spent lixiviant in situ through careful addition of a stronger acid. After reaction of the selective lixiviant with an excess of calcium oxide or hydroxide in the material to be extracted (which can be monitored by an increase in pH), addition of a stoichiometric or sub stoichiometric amount of strong acid relative to the spent lixiviant regenerates the weakly acidic lixiviant compound in the aqueous phase (Equation 9).

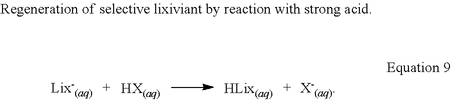

It should be appreciated that this regeneration reaction is extremely rapid, especially given the exceptionally high mobility of hydrogen ions in aqueous solutions. This means that the strong acid is rapidly consumed before interphase (aqueous-solid) deleterious reactions can occur appreciably (Equation 7 and Equation 8). By careful addition of multiple aliquots of strong acid to such a mixture, a calcium salt solution can be obtained. The counter anion in this case is primarily that of the strong acid, with a small quantity of the spent weakly acidic lixiviant. It is possible that a direct, aqueous reaction between the strong acid and dissolved calcium hydroxide can occur (Equation 10) in competition with the lixiviant regeneration, however this is both a minor effect due to the low solubility of lime and not a substantive issue since the product is the same desired calcium salt.

It should also be appreciated that other potential components in the material being extracted (e.g., MgO, Mg(OH)₂, FeO, Fe(OH)₂, Fe₂O₃, Fe(OH)₃, Al₂O₃, Al(OH)₃, SiO₂, etc.) typically have such extremely low solubility that there is no real competition for reaction over calcium hydroxide. If the quantity of strong acid added never exceeds that of the spent lixiviant in the aqueous phase, extraction of calcium proceeds with exceptionally high selectively.

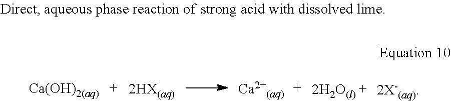

As noted above, calcium salt solutions prepared by methods of the inventive concept can be used directly, as-is or after additional processing (for example, by dilution or concentration by methods such as reverse osmosis, evaporation, and/or boiling). Alternatively, they can be used to make other calcium compounds. For example, with appropriate lixiviants (and therefore conjugate base solutions), calcium carbonate can be produced by addition of CO₂ to the calcium solution (Equation 11). This also regenerates the lixiviant initially used, which can then be reused in additional extractions. With judicious selection of weakly acidic lixiviant species it is possible to achieve appreciable product yields without difficult and expensive manipulations. If the lixiviant is too acidic, the reverse reaction is favored. This can be forced to some extent with more acidic lixiviants such as acetic acid by using high concentrations of CO₂ (e.g., through the application of CO₂ under pressure).

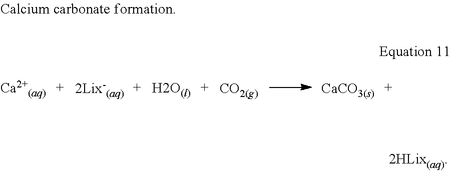

There are other post-extraction manipulations that may be desirable as well. For example, when the lixiviant is acetic acid, the resulting calcium acetate solution can be dried, and the solid salt decomposed to produce calcium carbonate and acetone (Equation 12).

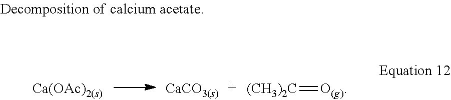

### EXAMPLE 1

4.39 g boric acid was dissolved in 100 g water and magnetically stirred at 500 rpm. 10 grams of BOF slag (<125 microns) was added. After one hour of mixing, the slurry was filtered, the solids washed with additional water and dried to a constant weight of 10.65 g, consistent with some hydration of the calcium oxide in the starting slag. The clear, colorless extract was found to form a precipitate with oxalic acid, consistent with some calcium being extracted as well. Application of CO₂ to the extract solution did not precipitate any solids. ICPMS analysis of the extract showed calcium in solution and analysis of the residue likewise showed depletion of calcium in the solids.

### EXAMPLE 2

4.25 g acetic acid was dissolved in 100 g water and magnetically stirred at 500 rpm. 10 grams of BOF slag (<125 microns) was added. After one hour of mixing, the slurry was filtered, the solids washed with additional water and dried to a constant weight of 7.39 g, consistent with significant extraction of calcium from the starting slag. Sparging the clear, colorless extract with CO₂ generated a cloudy solution, however no solid precipitate was isolated by filtration at atmospheric pressure. ICPMS analysis of the residue depletion of calcium in the solids.

### EXAMPLE 3

12.45 g ascorbic acid was dissolved in 100 g water and magnetically stirred at 500 rpm. 10 grams of BOF slag (<125 microns) was added. After one hour of mixing, the slurry was filtered, the solids washed with additional water and dried to a constant weight of 5.65 g, consistent with significant extraction of calcium from the starting slag. The extract solution was an intensely colored brown-red. ICPMS analysis of the extract showed a very high concentration of calcium in solution with very little impurities. Without wishing to be bound by theory, the Inventor believes that the coloration is a result of reduction of the ascorbic acid (which is a strong antioxidant). ICPMS analysis of the residue likewise showed strong depletion of calcium in the solids.

### EXAMPLE 4

13.52 g citric acid was dissolved in 100 g water and magnetically stirred at 500 rpm. 10 grams of BOF slag (<125 microns) was added. After one hour of mixing, the slurry was filtered, the solids washed with additional water and dried to a constant weight of 19.59 g, potentially due to precipitation of calcium citrate. The extract solution was a dark yellow-green color and ICPMS analysis showed a significant concentration of iron in solution.

### EXAMPLE 5

4.35 g boric acid was dissolved in 100 g water and magnetically stirred at 500 rpm. 10 grams of BOF slag (<125 microns) was added. After mixing overnight, the slurry was filtered, the solids washed with additional water and dried to a constant weight of 11.11 g, consistent with hydration of the calcium oxide in the starting slag. The clear, colorless extract was found to form a precipitate with oxalic acid, consistent with some calcium being extracted as well. ICPMS analysis of the extract showed calcium in solution and analysis of the residue likewise showed depletion of calcium in the solids.

### EXAMPLE 6

5.91 g of sodium bicarbonate was slowly added to 13.46 g citric acid dissolved in 100 g water, with stirring (500 rpm), to generate sodium dihydrogen citrate, and carbon dioxide byproduct which evolves form solution. 10 g of BOF slag (<125 microns) was slurried in the solution for 1 hour, then filtered, washed and dried to a constant weight of 16.53 g, likely from precipitation of the calcium citrate product. The extract solution was a yellow-green color and ICPMS analysis showed a significant concentration of iron in solution as well as some calcium.

### EXAMPLE 7

5.60 g of sodium hydroxide was dissolved in 100 g water. 13.5 g of citric acid was added to the basic solution, with stirring (500 rpm), to generate disodium hydrogen citrate. 10 g of BOF slag (<125 microns) was slurried in the solution for 1 hour, during which it becomes very thick. An additional 100 g water was added to thin out the solution before filtering, washing and drying the solids to a constant weight of 14.78 g, likely due to precipitation of products. The extract solution was a pale yellow-brown color and ICPMS analysis showed a much higher concentration of calcium than iron, relative to Example 6.

### EXAMPLE 8

7.45 g of 85% lactic acid was diluted with 100 g water and magnetically stirred at 500 rpm. 10 grams of BOF slag (<125 microns) was added and the slurry stirred for one hour before filtering, then washing and drying the to a constant weight of 7.20 g, consistent with significant extraction of calcium from the starting slag. The clear, colorless extract did not precipitate when sparged with CO₂. But when dried to a solid yielded 9.16 g of a clear, colorless glass. ICPMS analysis of the extract showed high selectivity for calcium in solution, as did analysis of the glass solids made therefrom.

### EXAMPLE 9

A 500 ml beaker was charged with 300 g water and 1.08 g acetic acid. This was then stirred at 500 rpm and a pH probe connected to a data logger was inserted into the solution. The pH of the solution was determined to be about 2.8. About 1 g of high purity calcium oxide was added to the solution, thereby bringing the pH up to about 12. Concentrated HCl (37%) was then used to adjust the pH to about 6.4.

In this manner a solution of calcium acetate and acetic acid (with some CaCl₂)) is generated at a very low acidity, which avoids unwanted low-pH metal extractions when the slag is added in the following step. Thirty grams of BOF slag (<125 microns) was added to this solution and the resulting suspension was stirred. The pH was observed to rise above 12. Small aliquots of 37% HCl were added during this step, being careful not to exceed the stoichiometric limit of the in-situ regenerable lixiviant (1.77 g 37% HCl maximum per aliquot calculated). Kinetics were very fast (possibly due to the small particle size) and no drastic drops in pH were observed. The total mass of 37% HCl to be added was calculated to be less than 15.95 g, so as not to exceed the known extractable amount of calcium oxide in the slag. The complete pH profile for this example is shown in Error! Reference source not found. When a total of 15.85 g of concentrated HCl was added, the mixture was filtered, the solids washed twice with about 50 ml of water and dried at 105° C. to a constant mass of 24.67 g. The mass of clear, colorless solution collected was 365.1 g and had a pH of about 11.5. Drying a small sample of the calcium salt solution gave an LOD of 96.2% at 105° C., which corresponds to a CaCl₂) concentration of 3.2%. ICPMS analysis of the extract showed excellent selectivity for Ca extraction with very small amounts (less than 10%, 8%, 6%, 4%, 2%, 1%, 0.5%, 0.25%, or 0.1% by weight of solids) of impurities (e.g., (Al, Mg, Si, Fe, Mn).

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1-10. (canceled)

11. A method for the recovery of an alkaline earth from a raw material comprising;
providing a raw material comprising an alkaline earth to a reactor;
in the same reactor, exposing the raw material to a weak acid lixiviant to generate an extracted raw material, a solubilized alkaline earth, and a spent lixiviant;
contacting the solubilized alkaline earth and the spent lixiviant with a precipitant, thereby generating an alkaline earth precipitate and a regenerated weak organic acid lixiviant; and
separating the alkaline earth precipitate from the regenerated weak acid lixiviant; and
returning at least a portion of the regenerated weak acid lixiviant to the reactor,
wherein the weak acid lixiviant does not include an amine.

12. The method of claim 11, wherein the precipitant is carbon dioxide, and wherein the weak acid is a weaker acid than carbonic acid.

13. The method of claim 11, wherein the weak acid is a weak organic acid that does not include an amine.

14. The method of claim 13, wherein the weak organic acid is selected from the group consisting of lactic acid, malic acid, and acetic acid.

15. The method of claim 11, wherein the extracted raw material is separated from a liquid phase containing the solubilized alkaline earth and the spent lixiviant prior to contacting with the precipitant.

16. The method of claim 11, wherein the extracted raw material is separated from the alkaline earth precipitate and from the regenerated weak organic acid lixiviant following contacting with the precipitant.

17. The method of claim 16, wherein separation is performed on the basis of density or particle size.

18. The method of claim 16, wherein the precipitant is introduced into the reactor in an essentially continuous manner.

19. The method of claim 16, wherein separating is performed in an essentially continuous manner.

20. The method of claim 11, wherein the extracted raw material is subjected to further processing.

21. The method of claim 11, wherein the alkaline earth is calcium.
